(19) United States
(12) Patent Application Publication
(10) Pub. No.: US 2012/0272207 A1
(43) Pub. Date: Oct. 25, 2012

(54) SOCIAL INTERACTIVE CODE DEVELOPMENT

(75) Inventors: Edward Lerner, San Francisco, CA (US); Charles Nicholson, San Francisco, CA (US)

(73) Assignee: Sony Computer Entertainment America LLC, Foster City, CA (US)

(21) Appl. No.: 13/091,084

(22) Filed: Apr. 20, 2011

(51) Int. Cl. G06F 9/44

(52) U.S. Cl. 717/102

(57) ABSTRACT

A system for social interactive code development of a plurality of code modules is provided. The system includes an activity monitor for monitoring access to one or more of the plurality of code modules. The system further includes a social feedback engine for initiating a communication based on triggering a predefined access threshold set for at least part of a specific one of the plurality of code modules.

### RELATED APPLICATIONS

This application is related to U.S. patent application Ser. No. ______, entitled “SOCIAL INTERACTIVE CONTENT CREATOR DEVELOPMENT,” filed ______, by inventors Edward Lerner and Charles Nicholson, the disclosure of which is herein incorporated by reference in its entirety.

### BACKGROUND

1. Field of the Invention

The present invention relates to methods and systems for social interactive code development.

2. Description of the Related Art

Traditionally, software developers work in teams and each developer or person is given the role or task to generate a particular module or piece of software for an overall project. During the development stages of the software project, team members will usually interface with each other once a day during a team meeting or periodically during the day as developers need feedback or share information as needed.

The problem with this methodology of producing a software product is that more than one developer will need to access the code of other co-developers for interactive development, interactivity, or to implement updates to a larger piece of code. When this type of interactivity occurs, developers usually access code produced by members of the team to sometimes modify, access, check out, or rewrite code that was written or produced by another team member. Changes to the code are not available for review until the code is checked back in. When the team member goes back to their code during their development cycle, the team member will notice that another team member modified their code or changed some aspect without their permission or discussion. As a result, the developer will waste time in making or undoing modifications to his or her code simply to address the changes made by another team member.

During the development process, a large amount of time is wasted redoing or making adjustments to code when members of the team access or modify the original code produced by a particular team member.

It is in this context that embodiments of the invention arise.

### SUMMARY

Embodiments of the present invention provide systems and methods for social interactive code development. It should be appreciated that the present invention can be implemented in numerous ways, such as a process, an apparatus, a system, a device or a method on a computer readable medium. Several inventive embodiments of the present invention are described below.

In one embodiment, a system for social interactive code development of a plurality of code modules is provided. The system includes an activity monitor for monitoring access to one or more of the plurality of code modules. The system further includes a social feedback engine for initiating a communication based on triggering a predefined access threshold set for at least part of a specific one of the plurality of code modules.

In one embodiment, the predefined access threshold is defined as one or more of opening, viewing, or editing the part of the specific one of the plurality of code modules. In one embodiment, the communication is directed to a user that triggers the predefined access threshold. In another embodiment, the communication is directed to an owner of the part of a specific one of the plurality of code modules.

In one embodiment, the communication comprises a real-time communication link. In one embodiment, the real-time communication link is defined between a user that triggers the predefined access threshold and an owner of the part of a specific one of the plurality of code modules. In various embodiments, the real-time communication link includes one of a live view and a history view of the part of the specific one of the plurality of code modules.

In one embodiment, the system further comprises a tag generator for generating a tag associated with the part of the specific one of the plurality of code modules, the tag defining the communication and the predefined access threshold.

In one embodiment, the initiation of a communication is based on a proximity of the part of the specific one of the plurality of code modules to another portion of one of the plurality of code modules. In one embodiment, the proximity is defined by a parent-child relationship.

In one embodiment, the system further comprises a user interface for providing access to one or more of the plurality of code modules. In one embodiment, the user interface includes a value data presenter for presenting value data regarding at least part of one or more of the plurality of code modules, the value data defining a relative level of importance. In one embodiment, the value data includes metrics derived from one or more of development time, play time, test time, and cost.

In another embodiment, a method for social interactive code development of a plurality of code modules is provided. The method initiates with monitoring access to one or more of the plurality of code modules. A communication is initiated based on triggering a predefined access threshold set for at least part of a specific one of the plurality of code modules.

In one embodiment, the method further includes generating a tag associated with the at least part of the specific one of the plurality of code modules, the tag defining the communication and the predefined access threshold. In one embodiment, the method further includes providing access to one or more of the plurality of code modules. In one embodiment, providing access includes presenting value data regarding at least part of one or more of the plurality of code modules, the value data defining a relative level of importance. In one embodiment, the value data includes metrics derived from one or more of development time, play time, test time, and cost.

Other aspects of the invention will become apparent from the following detailed description, taken in conjunction with the accompanying drawings, illustrating by way of example the principles of the invention.

### BRIEF DESCRIPTION OF THE DRAWINGS

The invention may best be understood by reference to the following description taken in conjunction with the accompanying drawings in which:

FIG. 1 illustrates a system for social interactive code development, in accordance with an embodiment of the invention.

FIG. 2 illustrates a system for social interactive code development, in accordance with an embodiment of the invention.

FIG. 3 illustrates a system for social interactive code development, in accordance with an embodiment of the invention.

FIG. 4 illustrates a code module having various associated tags, in accordance with an embodiment of the invention.

FIG. 5 illustrates an editing screen, in accordance with an embodiment of the invention.

FIG. 6 illustrates various options for setting a social feedback mechanism, in accordance with an embodiment of the invention.

FIG. 7 illustrates a social interactive development scenario, in accordance with an embodiment of the invention.

FIG. 8 illustrates a form 200 for setting an alert, in accordance with an embodiment of the invention.

FIG. 9 illustrates a graph of code violations per user, in accordance with an embodiment of the invention.

FIG. 10 illustrates parent-child relationships amongst a plurality of code modules, in accordance with an embodiment of the invention.

FIG. 11 illustrates periods of activation for various code modules over time, in accordance with an embodiment of the invention.

FIG. 12 illustrates the placement and review of a QA flag, in accordance with an embodiment of the invention.

FIG. 13 illustrates a management reporting system, in accordance with an embodiment of the invention.

FIG. 14 illustrates hardware and user interfaces that may be used to implement embodiments of the invention.

### DETAILED DESCRIPTION

The following embodiments describe methods and apparatus for social interactive code development.

It will be obvious, however, to one skilled in the art, that the present invention may be practiced without some or all of these specific details. In other instances, well known process operations have not been described in detail in order not to unnecessarily obscure the present invention.

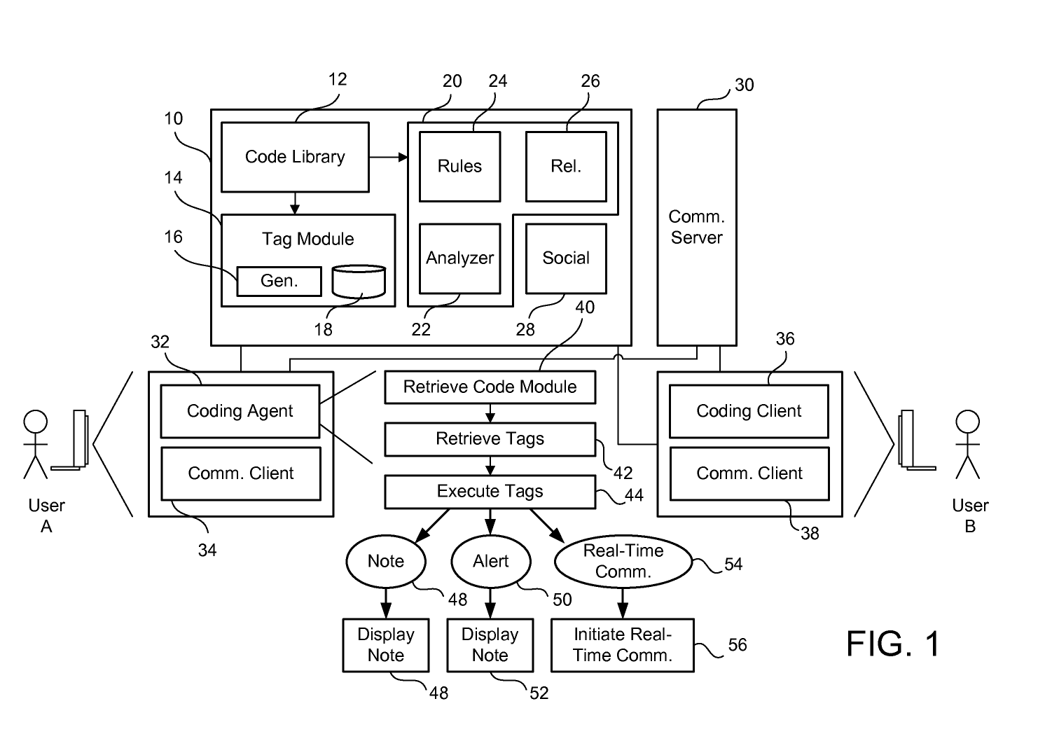

FIG. 1 illustrates a system for social interactive code development, in accordance with an embodiment of the invention. The system includes a code management system 10, which includes various modules for code development and management. The code management system 10 includes a code library 12, which stores various code modules under development. A tag module 14 includes a tag generator 16 for generating tags which are associated with the code modules or portions thereof. The tags are stored in tag storage 18. A proximity module 20 includes various components for determining proximity of code modules or portions thereof.

Two code modules or portions thereof are generally considered to be proximate to each other if they are related in some manner. Proximity can include many facets, including dependencies such as parent-child relationships, peer relationships, relationship to a same or similar module or object or subject matter, timing of execution, placement of execution, etc. A simple example considering two code modules for a video game serves to highlight possible proximity relationships. For example, two code modules might be considered to be proximate or related to each other if one or more of the following is true: one is a parent or child of the other, both are referenced as children of the same parent module, both relate to a same object within the game, both relate to a same level of play, both tend to be executed simultaneously, both relate to objects that appear in a similar location within the game (e.g. proximate location or within a same identified space such as a room or vehicle), etc. The proximity rules 24 govern the determination of which code modules or portions thereof are determined to be proximate to each other.

An analyzer 22 analyzes the code library 12 to determine, based on the proximity rules 24, which code modules or portions thereof are proximate to each other. The analyzer 22 can analyze the relationships amongst the code modules to determine which ones are proximate to each other. The analyzer 22 may also utilize additional information such as historical data about the code modules to determine proximity according to the proximity rules 24. The historical data can include any type of data which may be useful in determining proximity of code modules, such as time of execution, location of execution, etc. The analyzer 22 determines proximity amongst the code modules based on the proximity rules 24 and stores these determined relationships in a proximity relationship storage 26. It will be noted that proximity relationships are generally determined by the analyzer 22, but may also be manually defined. For example, an owner of a particular module, or a specific user with authorization to do so may specifically define a proximity relationship between code modules or portions of code modules.

A social feedback engine 28 utilizes the proximity relationships and initiates a communication based on detected access activity of the code modules. For example, in the illustrated embodiment, a user A is accessing a specific code module via a coding client 32 for which a proximity relationship exists to a proximate code module owned by user B. The social feedback engine might alert user A to the existence of the proximity relationship based on the detected access activity, indicating that changes to the specific code module may affect the proximate code module, and that the user A may wish to communicate with user B. Such an alert may be generated in response to various types of access activity, such as opening the specific code module for editing or performing an edit to a particular portion of the specific code module. In one embodiment, the social feedback engine could provide mechanisms for easily initiating communication with user B, such as by initiating an e-mail to user B or initiating a chat window with user B. In one embodiment, the social feedback engine indicates to user A whether or not user B is online, and facilitates initiation of a communication. The communication may entail transmission between a communication client 34 of user A and a communication client 38 of user B via a communication server 30. Examples of types of communication include e-mail, text chat (instant messaging), voice chat, video chat, and the like.

In another embodiment, the social feedback engine 28 could respond to detected access activity wherein user A and user B are accessing related code modules. Simultaneous changes to proximate code modules by different parties can be problematic, as the changes may not be coordinated so as to avoid compatibility issues or other types of issues. Thus, when user A and user B are simultaneously accessing related code modules, or portions thereof, the social feedback engine 28 may initiate a communication between user A and user B. The social feedback engine may alert both user A and user B that the other is simultaneously working on a related code module, and initiate a mechanism for communication, such as a chat session via the communication server 30.

In one embodiment, the code management system 10 includes a tag module 14. The tag module 14 includes a tag generator 16, and a tag storage 18. Tags will be generally understood as user-defined items which are associated with a code module or a portion of a code module. Tags can include descriptive data related to the code, such as information about the code such as its owner, contents, features, special requirements, related code modules, or other information. Tags may define certain restrictions or permissions, and may also define certain actions which can be initiated in response to certain activities such as opening, viewing, or editing a code module.

As shown with continued reference to FIG. 1, in one embodiment, the user A utilizes coding client 32 to open a specific code module. At a method operation 40, the coding client 32 retrieves the code module. At operation 42, tags associated with the specific code module are also retrieved. And at operation 44, the tags are executed. In one embodiment, the tag may define a note 46. Thus, at operation 48, the note is displayed in response to a particular action, such as opening or viewing the code module, or hovering a pointer over a portion of the code module, or performing an edit to a portion of the code module.

In one embodiment, the tag may define an alert 50. At operation 52, an alert is sent in response to a certain action being taken with regard to the code module, such as opening or editing the code module. An alert can be sent to designated parties, such as an owner of the specific code module, or an owner of a related code module that may be affected by edits to the specific code module, merely by way of example. Alerts can be communicated according to any number of communication methods, such as e-mail, instant messaging, text messaging, or other methods of communication. Alerts can be defined to transmit various kinds of information for various purposes.

For example, in one embodiment, an alert may be defined to notify the owner of the specific code module of the type of change which has been made to it. In another embodiment, an alert may be configured to be transmitted only when a specific type of change as occurred. For example, a user attempting to perform the specific type of change may be presented with a notification that an alert will be sent to the owner of the code module if the change is made. Thus, the tag defines a restriction wherein the specific type of change cannot be made without alerting the code module owner.

In other embodiments, an alert may be defined to notify owners of related code modules of a change made to a specific code module. The alert may be defined to specify the nature of the change, such as by including the code text with the change highlighted. In this manner, owners of related code modules can be informed of changes to certain code modules which may affect their code modules.

In one embodiment, the tag may define a real-time communication 54. At operation 56, the real-time communication between user A and user B is initiated based on an event defined by the tag. In one embodiment, initiation of the real-time communication between user A and user B is facilitated by user A's communication client 34 and user B communication client 38, via communications server 30. Examples of real-time communication include text chat, voice chat, video chat, etc. As with the aforementioned notes and alerts, the real-time communication may be triggered by the occurrence of particular events as defined by the tag. These may include various types of activities relating to a specific code module, such as opening or editing the code module. In one embodiment, the tag is defined to suggest to user A that a real-time communication with user B should occur based on user A's activities. The online/offline status of user B may be displayed in conjunction, such that User A may invite user B to a real-time chat, by way of example.

In one embodiment, user A edits a specific code module of which user B is the owner. A tag associated with the specific code module is executed, the tag defining a real-time communication with user B when a certain type of edit is performed to the specific code module. Thus, if user A performs the type of edit as defined by the tag, then user A is informed that a real-time communication is advised with user B, and user A may be presented with an option to invite user B to engage in a real-time communication. In this manner, an owner of a code module can be notified via a real-time communication of a potential change to their code module. In another embodiment, the user B may be an owner of a related code module. In this manner, an owner of a related code module can be notified of potential changes which may affect their code modules.

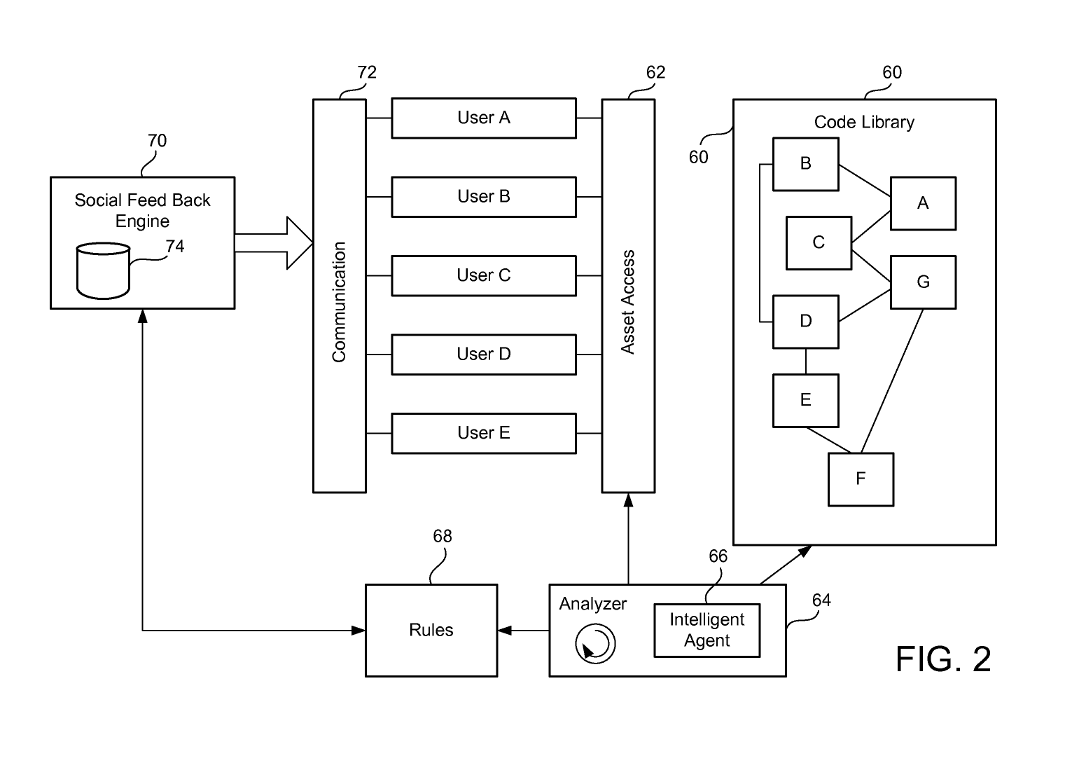

FIG. 2 illustrates a system for social interactive code development, in accordance with an embodiment of the invention. A code library 60 includes various code modules of a development project. Users A, B, C, D, and E access the code modules of the code library via an asset access module 62. The asset access module 62 may handle various functions related to access of code modules, such as checking out or checking in code modules, providing a user interface for viewing or editing code modules, etc.

A rules module 68 includes various rules which are defined for interacting with the code modules. The rules for a specific code module can be defined by those with authority to do so, such as an owner of the code module. The rules can take on any number of forms and can be defined with great particularity depending on the sensitivity of the module being coded. Merely by way of example, the rules can define various functions, such as identifying who is interfacing or interacting with the code by way of a message to the owner of the module, identifying who is touching a file or accessing a file, who is making changes to the module, the types of changes being made to the module, if a piece of the module code is being checked out, etc. Rules can also define various permissions such as whether a particular team member has authority to control the code, authority to rewrite the code, authority to change an API, etc.

An analyzer engine 64 includes an intelligent agent 66 which monitors the code modules and the interactivity by the various users. The intelligent agent 66 monitors various types of interactions with the code modules, such as who is interacting with or accessing a file, changes to code modules, check outs, re-writing, API changes, etc. The analyzer engine 64 can also analyze the code modules and their interdependencies and interactivity and may determine new rules based on existing rules. For example, a generic rule may specify that for code modules having a certain relationship, a change to one of the code modules requires a notification to the owners of the other code modules. The intelligent agent 66 may then analyze the code modules and determine which of the code modules have the specified relationship, and define rules specific to those code modules based on the generic rule.

Based on the rules and the actual interactivity by the users that may be accessing either their own modules or modules of others, a social feedback engine 70 initiates social interactive communication amongst the users. The communication is mediated by a communication module 72, and can include various forms of communication, such as various types of messaging, notification, e-mail, chat, and various other real-time or non-real time communication methods. The social feedback engine 70 includes a historical data storage 74, which contains historical social interactive communication data. The historical data storage 74 provides a log of social interactive communications, which can be reviewed and analyzed to understand how development occurred and how it might be improved.

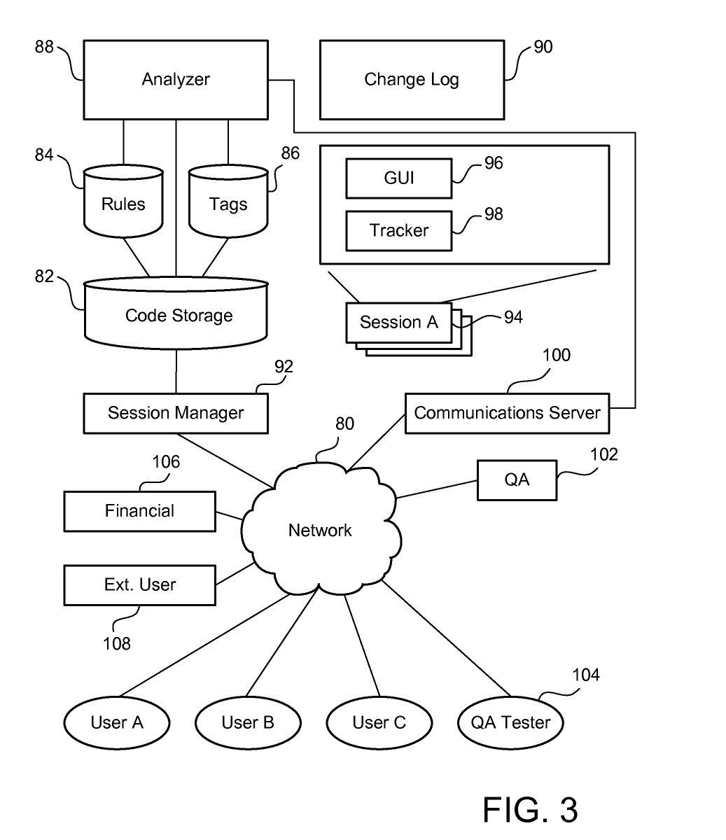

FIG. 3 illustrates a system for social interactive code development, in accordance with an embodiment of the invention. Various components of the system are connected via a network 80. The network 80 can be any type of network which can facilitate data and communications transfer, such as a LAN, WAN, the Internet, or other types of networks. A code storage 82 stores code which is being developed. The code storage 82 can include various code modules and tools. A rules module 84 includes rules for interaction with the code, such as defining various restrictions or requirements for the code. A tag storage 86 stores various tags which are defined for the code or for portions thereof. An analyzer 98 analyzes the interactions with the code, and based on the rules or tags, triggers various kinds of communications via a communications server 100.

In one embodiment, a session manager 92 manages sessions for interacting with the code. For example, a user A may open a session 94 for interacting with one or more of the code modules. The session 94 includes a graphical user interface (GUI) 96 for interacting with the code. The session also includes a tracker 98, which tracks the interaction with the code during the session 94. The tracked interactions are fed to the analyzer 88, which analyzes the interaction with the code, and based on the rules or tags, may initiate communications via the communications server 100.

In one embodiment, a quality assurance (QA) module 102 is provided for performing QA testing of the code. A QA tester 104 interfaces with the QA module 102 to execute and test the code. In one embodiment, the QA module 102 provides an interface for testing wherein the QA tester 104 is able to set flags during the execution of the code which indicate the location of a bug. The flag is associated with one or more of the code modules, or portions thereof. The communications server 100 is then engaged to notify the owners of the appropriate code modules of the existence of the bug. The notification may include various kinds of information which may be useful for diagnosing and patching the bug, such as a screenshot or video capture of the executing program illustrating the bug.

In one embodiment, the communications server 100 may be engaged to initiate a real-time communication between the QA tester 104 and the owner of a code module for which a flag has been placed indicating the existence of a bug. For example, in one embodiment, the QA interface enables the QA tester 104 to see the online status of the owner of the relevant code module for which the flag has been placed, and given the option to initiate communication with the code module owner. In another embodiment, the owner of a code module may receive a notification indicating that a flag has been placed. The code module owner may also see the online status of the QA tester who placed the flag, and be presented with an option to initiate real-time communication with the QA tester if they are available.

In one embodiment, the foregoing systems may also be linked to other types of systems such as a financial system 106. Financial data from financial system 106 can be integrated with the social interactive code development system in various ways. For example, in one embodiment, financial data pertaining to individual code modules can be viewed in real-time, so that a developer may have a sense of how their editing of a code module may potentially affect revenue generated by the code module. Or management personnel may be able to generate reports so as to evaluate code modules in light of financial data.

In one embodiment, an external user data module 108 provides data regarding use of the code modules by external users. This data can be incorporated into real-time editing processes, so that developers can better understand how code modules are utilized by users and how edits may potentially affect such use.

The foregoing systems are provided as exemplary embodiments for social interactive code development. During a team development process, a large amount of time is wasted redoing or making adjustments to code when members of the team access or modify the original code produced by a particular team member.

However, by proactively injecting a level of social interactivity between the team members, it is possible to over come the drawbacks of rewrites, corrections, and bugs that get injected into code due to lack of interactive communication between team coders.

Certain advantages of the aforementioned systems include, for example, allowing each team member to monitor who is accessing their code, why they are accessing their code, and interact with the team members for a more coherent production of the product. Another advantage is that real-time social feedback will allow each of the users that form a team of software coders to monitor their code for real-time editing and to inject their feedback during the development by others.

In some cases, the feedback or interactivity by others to a piece of code is saved to a file. The owner of the piece of code can then later access the file to identify the history of changes, edits, or violations of the rules set by the owner of the piece of code. In some embodiments, the history file can be used to analyze performance or generate histograms of the development process. In some cases, the histograms can identify which coders (team members) were creating more violations during the development of the product. Further, the histograms can identify the types of violations that are occurring repetitively by certain team members. Based on this data, the team members can be reorganized by levels of expertise in order to reduce the number of violations of the various code pieces.

In still another embodiment, it is possible to identify if new team members are proficient in their development skills when the new team members are added to a new project. If the new team member is added to the project and the histogram shows that their access of code causes a high level of rule violations, it is possible that the new team member is unfamiliar with the product or needs retraining.

In still another embodiment, the feedback and histogram information can be automatically added to a knowledge base that fine-tunes the various rules set by the individual owners of the pieces of code. The tuning process can be a learned tuning process that optimizes the various rules to avoid violations when those violations do not affect the functionality of the code. In some cases, the learning process may provide suggested tags to place on code so that an owner of the piece of code can better define his or her rules and make the team socializing regarding the development of the product more effective as a whole.

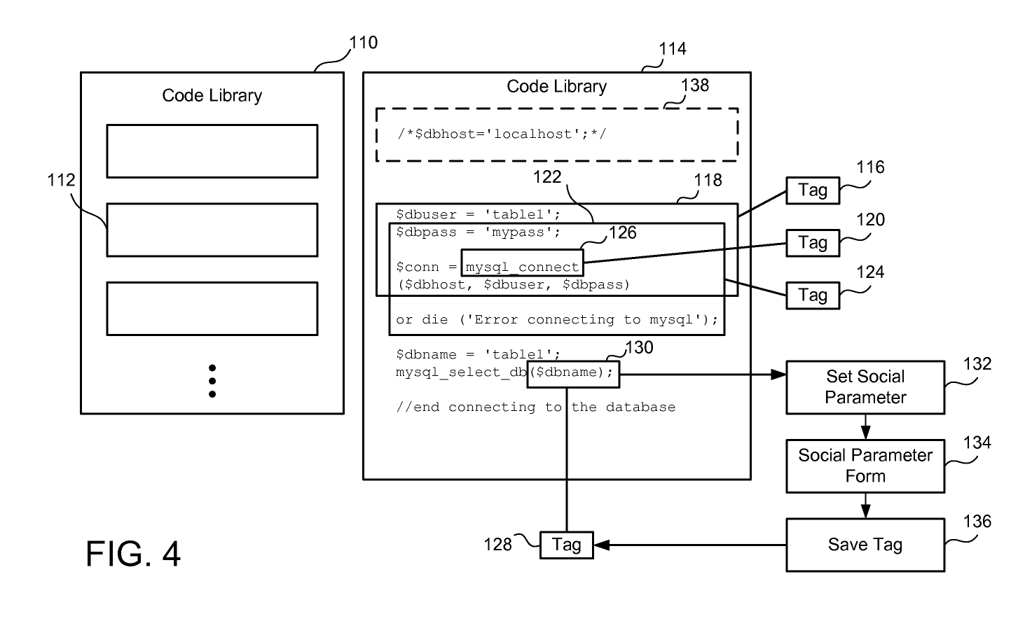

FIG. 4 illustrates a code module having various associated tags. As shown, a code library 110 includes a code module 112. A text view 114 of the code module 112 illustrates various portions of the code module 112. In various embodiments, tags may be assigned to portions of the code module 112 in various ways. A tag 116 is assigned to a portion of code 118; a tag 120 is assigned to a portion of code 122; a tag 124 is assigned to a portion of code 126. The portion of code to which a tag may be assigned can vary in size from a portion of a line of code, to a line of code, to entire sections of code or the entirety of a code module. As an example, tag 120 is assigned to portion 126 which a portion of a line of code, whereas tag 116 is assigned to portion 118 which is a section of code. Portions of code to which tags are assigned may overlap with each other or may be nested inside each other. For example, portion 118 overlaps with portion 122. Whereas portion 126 is nested inside of both portions 118 and 122.

A tag 128 is associated with portion 130 of code module 112. Various method operations are initiated to set the tag 128. At operation 132 a user designates the portion 130 to set a social parameter. In one embodiment, this is performed by highlighting the portion 130 and selecting a menu option to set a social parameter. Then at operation 134, the user indicates the specifics of the tag to be set via a social parameter form. The social parameter form provides options for the user to customize the details of the tag. And at operation 136, the tag is saved as tag 128. Tag 128 will subsequently be retrieved when a user opens the code module 112, and executed at the relevant time so as to provide a social feedback mechanism in response to a detected activity relating to the portion 130.

A comments portion 138 of the code module 112 is shown with continued reference to FIG. 4. In one embodiment, tags may be implemented as comments within a code module, utilizing the comment syntax of the particular programming language of the code module. In other words, the tags are defined utilizing the comment syntax of the programming language and stored as part of the code. Thus, the comments portion 138 may include tag definition information such as a portion of the code module to which a tag will pertain, a triggering activity related to the portion of the code module, and a social feedback response. When the code module is opened by a sophisticated editor, such as in the aforementioned systems which provide for social interactive development, then the information contained in the comments portion 138 is read and interpreted as tags, and executed to provide social feedback when appropriate activity is detected.

Additionally, tags implemented as such may include user-readable text that can be read and understood by a user. For example, information such as the owner of a particular module or descriptions or notes regarding portions of the code module might be included in a user-readable text form. Thus, text defining the tags may be configured to be easily read and understood in its native text form. In this manner, information embodied in the tags can still be understood when a code module is opened with a simple text editor or similar reading or editing program that does not have the ability to interpret and execute tags.

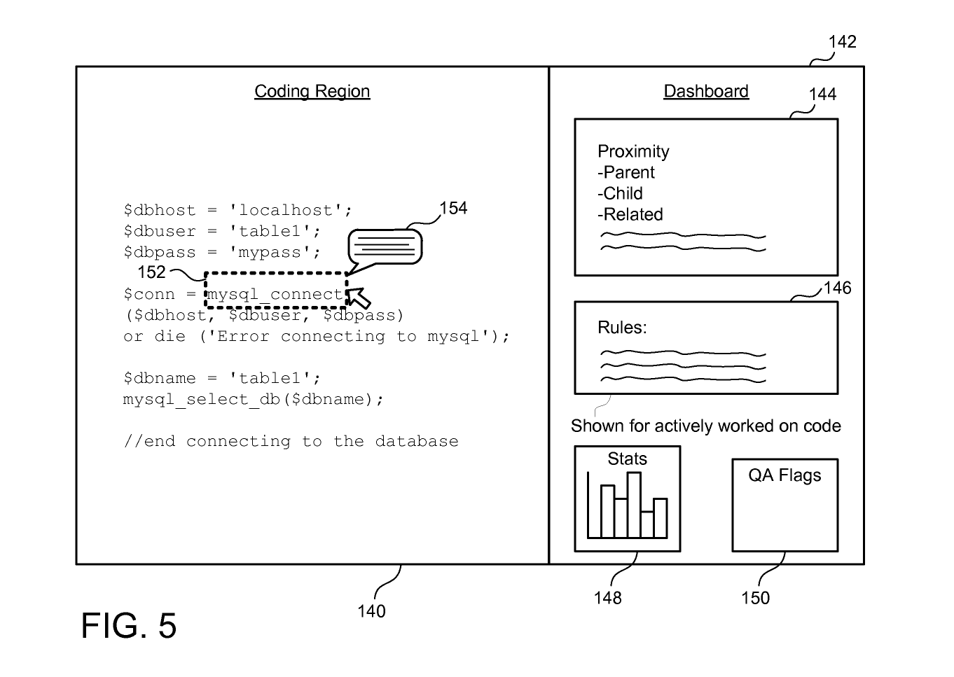

FIG. 5 illustrates an editing screen, in accordance with an embodiment of the invention. A coding region 140 includes the code text of a code module, in which a user may view and edit the code. A dashboard region 142 includes various sections displaying information related to the code module currently being edited. A proximity section 144 displays proximity relationships of the code module or portion thereof being currently viewed to other code modules or portions. The proximity section can list names of proximate code modules as well as the names of the owners of the proximate code modules, so that a user can know who they may wish to communicate with due to their ownership of a proximate code module.

A rules section 146 displays rules pertaining to the code module. In one embodiment, the rules are shown for the code that is actively being worked on, and are updated in real-time. Thus, as the user works on different parts of the code, different rules may be shown which pertain to the portions which the user is actively working on.

In one embodiment, the dashboard region 142 includes a statistics section 148 which displays statistics relevant to the code module or portion thereof being worked on. The statistics section 148 may be configured to display various types of statistics regarding the code which may aid the user in determining how and what modifications to make, if any. For example, in one embodiment, the statistics section 148 provides a measure of the amount of resources which have been expended on the code module or portion, such as the amount of time spent on development, the cost of development, the number of different users who have accessed or contributed to the development, etc. In one embodiment, the statistics section 148 provides a measure of the importance or significance of the code module or portion, such as the number of times the module or portion has been executed, the percentage of time the code module or portion is executed or active relative to the total run time of the entire project, the amount of revenue generated by the code module or portion, etc.

By providing an indication of the significance of the code module or portion thereof which a user is working on, the user can be better informed about how their editing activity may impact the overall project. For example, a user may be especially mindful about making changes to a code module which is active for a relatively large amount of time or which generates a high amount of revenue, as such changes may have a significant impact. Also, a user may be able to target code modules or portions thereof which are active for a relatively small amount of time or which generate a relatively low amount of revenue as code modules which may benefit from extensive modification so as to increase their measures of significance.

In one embodiment, a QA flags section 150 is provided as part of the dashboard 142. The QA flags section 150 displays information related to QA flags which may pertain to the code module or portion thereof being currently viewed or edited. For example, the QA flags section 150 may display information such as the specific code module or portion thereof to which the flag pertains, a virtual location (e.g. coordinates in a virtual space) at which the flag was set, the date and time the flag was set, the name or id of the user who set the QA flag, the online status of that person, etc. In one embodiment, the QA flags section 150 includes links to further detailed information about QA flags which are associated with current code module or portion thereof. For example, a link to a screenshot or video capture showing the QA flag could be provided, as well as links to other information.

In one embodiment, the QA flags section 150 provides an option to initiate a communication with a user who set a QA flag. For example, in one embodiment, the online status of the user who set a flag is indicated, and if the person is online, then an option is provided (such as by clicking on the person's name or user id) to initiate a communication with the person, such as an e-mail communication or a real-time communication such as a text/audio/video chat session. In this manner, a user viewing or editing a code module is able to efficiently review QA flags and communicate with the user who set a given QA flag if necessary.

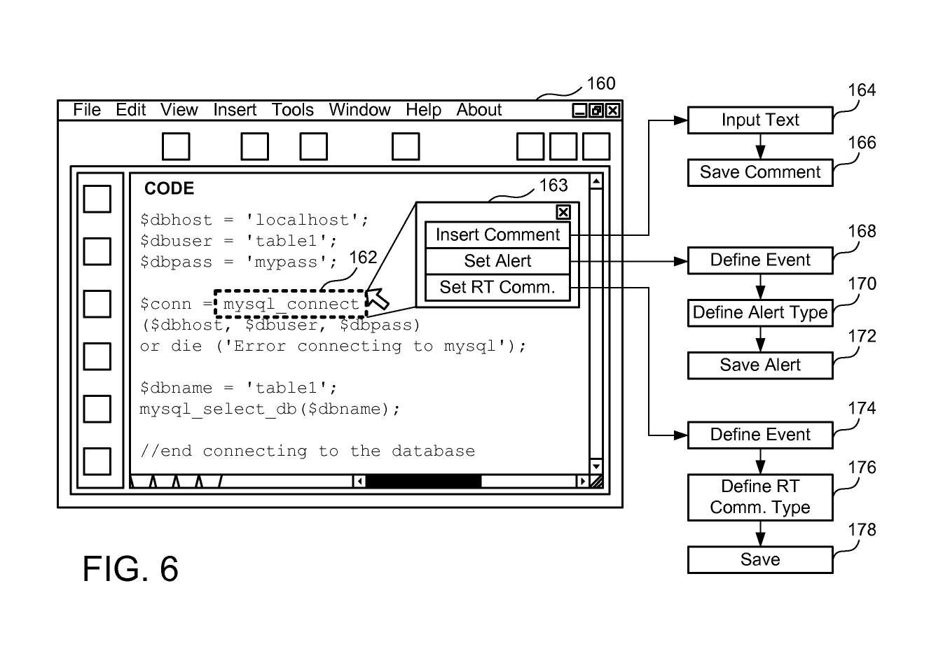

FIG. 6 illustrates various options for setting a social feedback mechanism. As shown, a code portion 160 is being viewed or edited by a user. According to one embodiment, the user highlights a portion 162 of the code, and activates a menu 163 containing options for setting a social feedback mechanism. By way of example, the menu 163 may be activated by utilizing a menu bar, pressing a button or other trigger device such as an auxiliary button on a mouse, etc. In the illustrated embodiment, the menu 163 includes options for inserting a comment, setting an alert, or setting a real-time communication.

In one embodiment, the user may set a comment that will be associated with the selected code, and displayed when the selected code is viewed or edited. To insert a comment, at operation 164, a text input by the user is utilized to define the comment. And at operation 166, the comment is saved and associated with the selected code portion. In various embodiments, the comment may be shown based on various kinds of triggering mechanisms. For example, the comment may be shown when the user hovers a pointer over the selected portion of code, or the comment may be shown alongside the code or in a dashboard section. The selected code may be highlighted or have an indicator which indicates the existence of the comment.

In one embodiment, the user may set an alert that will be associated with the selected code. To set an alert, at operation 168, the user defines a triggering event for the alert. The triggering event can be any event related to the selected code portion for which the user wishes to trigger an alert to be sent. For example, the triggering event may be any kind of edit made to the selected code, or may be more narrowly defined as a specific type of edit made to the selected code. At operation 170 the type of alert is defined. By way of example, the alert may be defined as utilizing a specific communication method, such as e-mail or text messaging. Additionally, the recipient of the alert when triggered is also defined, such as an owner or a user of the code module. The specific text of the alert may also be defined. At operation 172, the alert is saved and associated with the selected code.

In one embodiment, the user may set a real-time communication event that will be associated with the selected code. To set a real-time communication, at operation 174, the user defines a triggering event for the real-time communication event. The triggering event can be any event related to the selected code portion for which the user wishes to trigger a real-time communication, such as a type of edit made to the selected code. At operation 176 the type of real-time communication is defined. By way of example, the real-time communication event may be defined as utilizing a specific real-time communication method, such as text chat, voice chat, video chat, etc. In one embodiment, the real-time communication event is defined as providing the user viewing or editing the selected code portion the option to initiate a real-time communication with another user, such as an owner of the code module, or an owner of a related code module. The user may be able to view the online status of the owner or person for whom the real-time communication event is defined. At operation 178, the real-time communication event is saved and associated with the selected code.

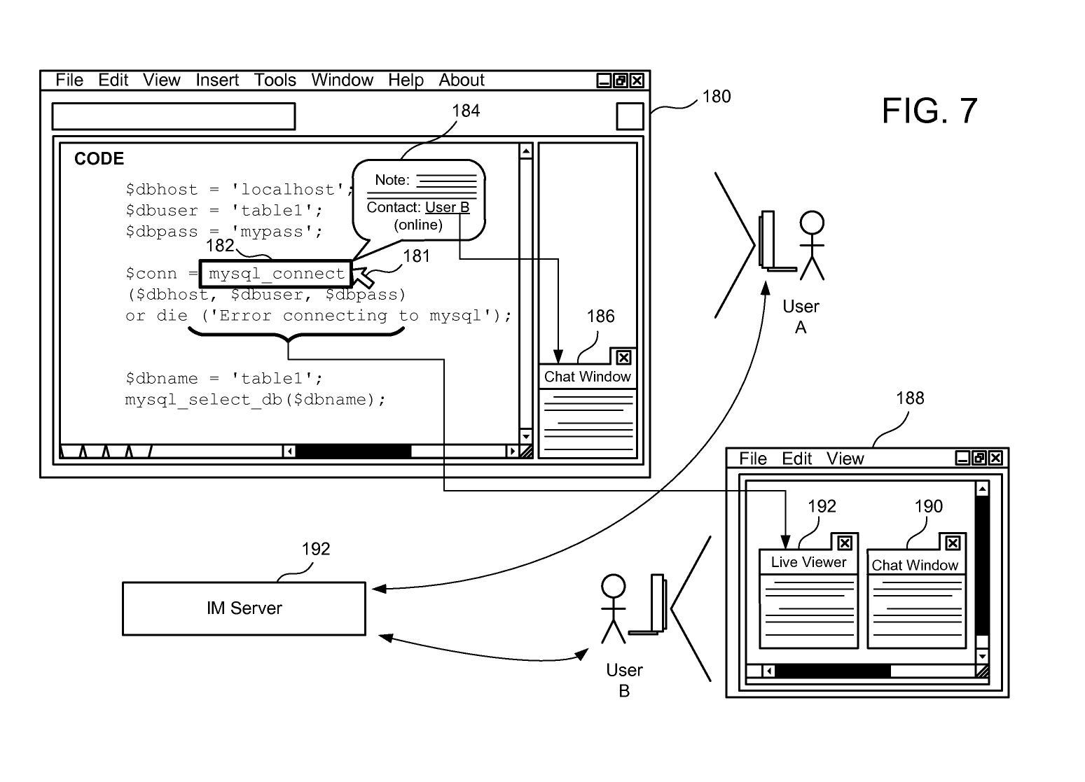

FIG. 7 illustrates a social interactive development scenario, in accordance with an embodiment of the invention. As shown, user A is working on developing a portion of code, and views a display screen 180. As shown in user A's display screen 180, user A has hovered a pointer 181 over a code section 182 for which a note or comment has been associated. The note 184 is displayed as a result, including text information about the code section, as well as a contact. The contact is a user B, whose online status is indicated as being currently online and therefore available to chat. By clicking on user B's name in the note, user A can open up a chat window 186 to connect with user B. On user B's display screen 188, a corresponding chat window 190 is opened so that user A and user B can chat in real-time. Additionally, user B has access to a live view 192 of the portion of code which user A is currently editing. In one embodiment, the real-time chat is facilitated by an instant messaging server 192.

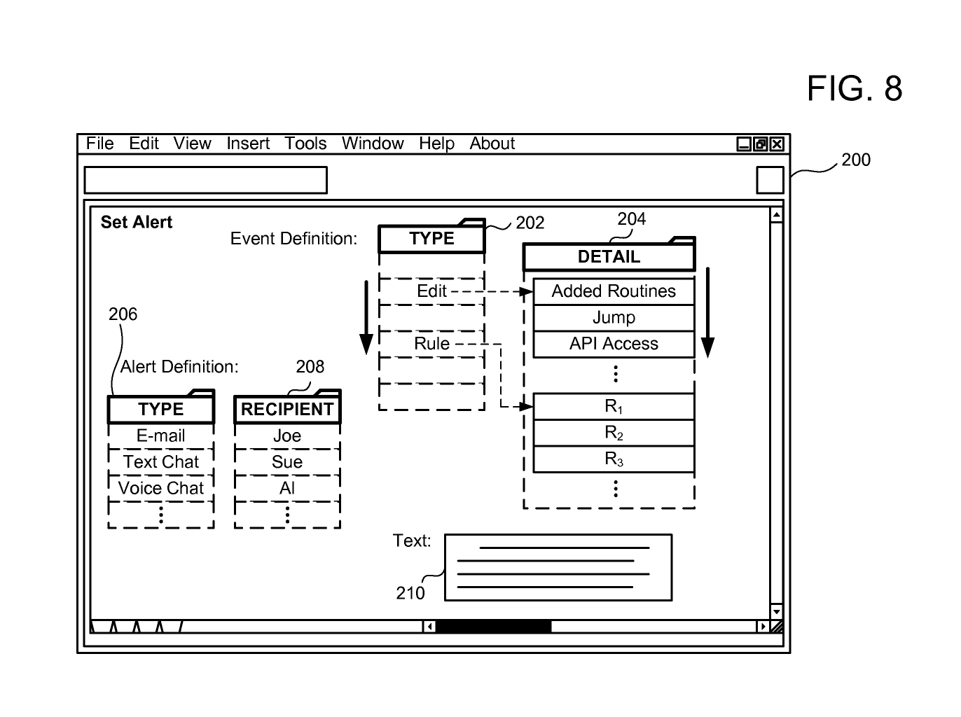

FIG. 8 illustrates a form 200 for setting an alert, in accordance with an embodiment of the invention. The form 200 may be utilized to set and associate an alert with a section of code. In the illustrated embodiment, the form 200 includes an event definition section, whereby the user may define a type of event and more specific details about the event for which an alert will be sent. According to one embodiment, a drop-down menu 202 is provided for defining the type of event, such as an editing event or a rule violation. Similarly, a drop-down menu 204 is provided for defining additional detail about the type of event. For example, if the event type is an editing event, then the user may select from options in the menu 204 such as an added routine, a jump, an API access, etc. Likewise, if the event type is defined as a rule violation, then the user may select from menu 204 various specific rules R1, R2, R3, etc. The form 200 also includes an alert definition portion for defining a type of alert and a recipient for the alert. In one embodiment, a drop-down menu 206 is included for defining the type of alert that will be sent, such as an e-mail, text chat, voice chat, text message, etc. Similarly, a drop-down menu 208 is included for setting the recipient of the particular type of alert. In one embodiment, a text box 210 is included for entering text that will be included in the alert defined by the form 200 when the alert is sent.

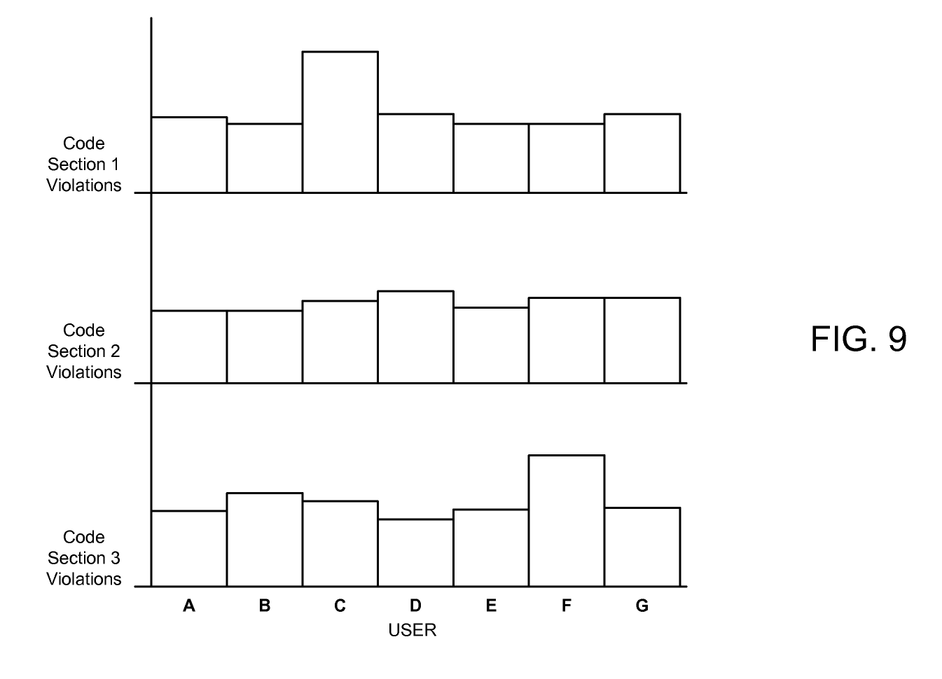

FIG. 9 illustrates a graph of code violations per user, in accordance with an embodiment of the invention. As discussed elsewhere herein, rules can be assigned to code modules, and systems can be configured to provide social feedback in response to violations of the rules. Accordingly, data relating to users' rule violations can be stored and subsequently analyzed. As shown, the number of code violations for various code sections 1, 2, and 3 are graphed for users A through G. For code section 1, user C exhibits the highest number of code violations, with the remaining users having a similar level of code violations. For code section 2, all of the users have a relatively similar level of code violations. And for code section 3, user F exhibits the highest number of code violations, with the remaining users exhibiting fairly similar levels of code violations. Based on this data, it is apparent that user C exhibits an unusually high number of violations for code section 1, but not for code sections 2 or 3. Similarly, user F exhibits an unusually high number of violations for code section 3, but not for code sections 1 or 2. A manager may utilize this information to decide upon a course of action for reducing the number of rule violations. For example, it may be determined that user C should be reassigned to a code section other than code section 1, or that user C should undergo training to become better acquainted with certain rules.

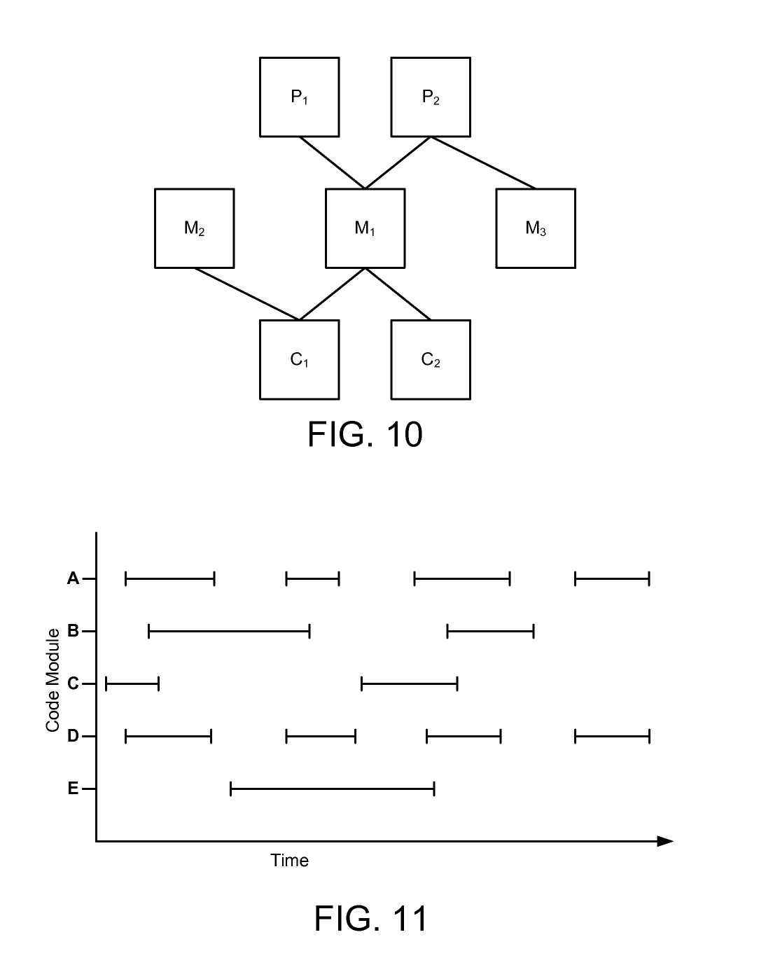

FIG. 10 illustrates parent-child relationships amongst a plurality of code modules, in accordance with an embodiment of the invention. As discussed elsewhere herein, proximity between code modules can be based on various factors such as parent-child relationships. As shown in the illustrated embodiment, a code module M₁ may be considered proximate to code modules P₁ and P₂, which are both parents of M₁. Code module M₁ may also be proximate to code module M₃, as code modules M₁ and M₃ are both children of code module P₂. Code module M₁ may also be considered proximate to code modules C₁ and C₂, as C₁ and C₂ are children of M₁. Also, code module M₁ may be considered proximate to M₂, as code module C₁ is a child of both code modules M₁ and M₂.

FIG. 11 illustrates periods of activation for various code modules over time, in accordance with an embodiment of the invention. Periods of activation are illustrated as line segments for each of code modules A, B, C, D, and E. As shown, the periods of activation for code modules A, B, C, and E generally do not bear any relation to one another. However, the periods of activation for code modules A and D are fairly similar. From this it may be concluded that code modules A and D can be considered proximate to one another, as they tend to be active during the same time periods.

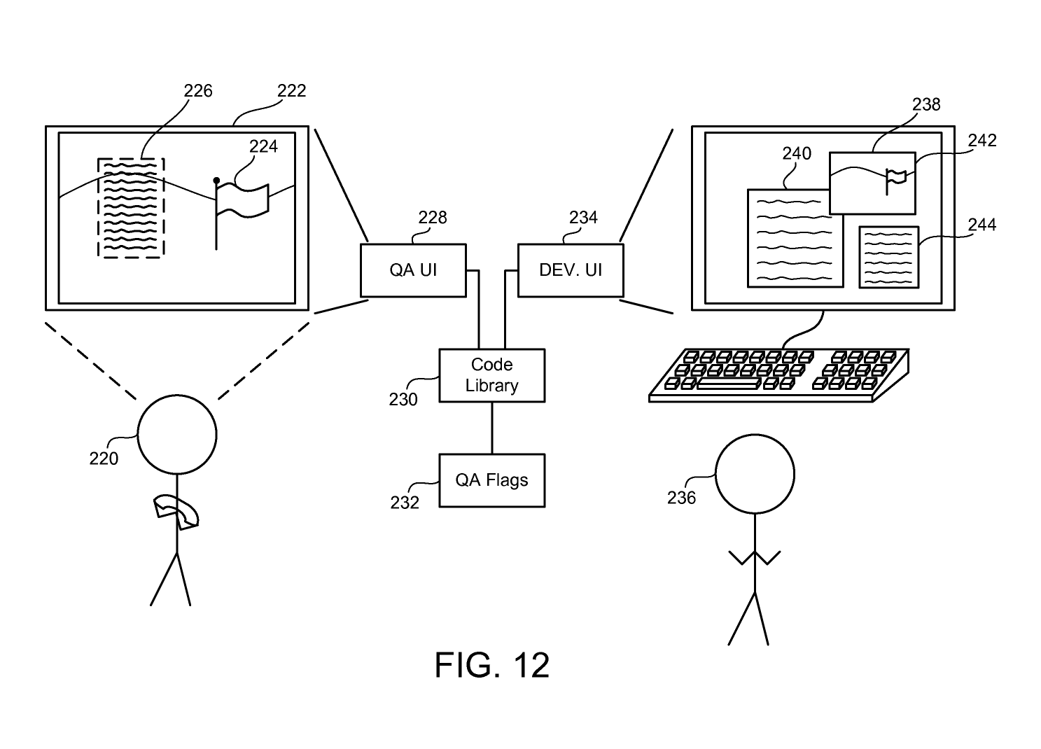

FIG. 12 illustrates the placement and review of a QA flag, in accordance with an embodiment of the invention. As shown, a QA tester 220 is testing a virtual environment as defined various code modules of a code library 230. For example, in one embodiment, the code modules define a video game, and the QA tester 220 tests the virtual environment of the video game by playing through the video game. The QA tester utilizes a QA user interface 228, which produces the display screen 222 that is viewed by the QA tester 220. As shown on the display screen 222, the QA tester 220 has placed a virtual QA flag 224 at a specific location (both geographically and temporally) within the virtual environment of the video game. The QA flag 224 is placed to indicate the presence of an issue or bug that requires review by a developer. Additionally, the QA tester 220 has entered descriptive information about the issue in a text window 226 for review by the developer. The QA flag and associated descriptive information are stored by a QA flags module 232 and associated with one or more of the code modules of the code library 230.

A developer 236 is an owner or developer of a specific code module for which the QA flag 224 is associated, and therefore notified of the QA flag. The developer 236 accesses the specific code module and reviews the QA flag via a developer user interface 234. The developer user interface 234 is rendered as display screen 238, including an editing window 240 for editing the code of the specific code module. Additionally, a screenshot or video clip 242 shows the rendered virtual environment in which the QA flag 224 was placed by the QA tester 220. Also, a window 244 displays information about the QA flag 224, such as the descriptive information entered by the QA tester 220. In one embodiment, the information includes the id and online status of the QA tester 220 who set the QA flag 224. The developer 236 may be presented with options to initiate communication with the QA tester 220, such via e-mail or a real-time chat. In this way, the developer 236 is timely informed of QA issues and able to effectively address them in a social interactive manner.

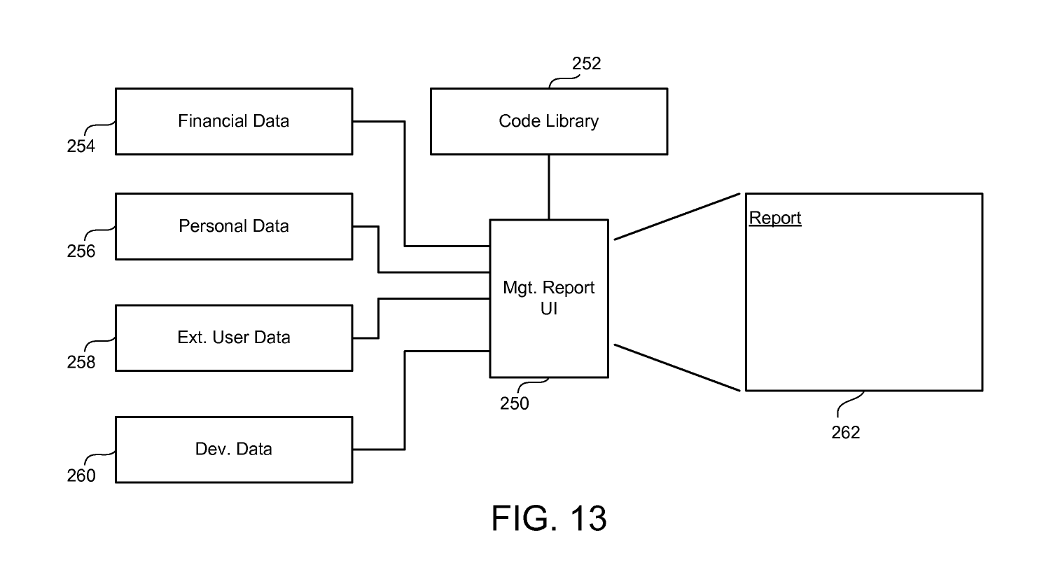

FIG. 13 illustrates a management reporting system, in accordance with an embodiment of the invention. Various systems for providing social interactive code development are described herein. Data generated by such systems may be combined with data from other types of systems and modules to provide expanded reporting possibilities. As shown in the illustrated embodiment, a management report user interface (UI) 250 provides an interface for generating reports regarding code library 252 based on integrated data from various systems. In one embodiment, a financial data module 254 provides financial data pertaining to the code library 252 such as the revenue generated by various code modules and various costs associated with the code modules. In one embodiment, a personnel data module 256 provides data relating to personnel involved in the development of the code library 252. In one embodiment, an external user data module 258 provides data based on external users' interactions with the code modules of the code library 252. In one embodiment, a development data module 260 provides data relating to the development of the code library 252. These and other sources of data are utilized by the management report UI 250 to generate a report 262.

In various embodiments, report 262 may include various combinations of information relevant to the code library 252. For example, report 262 may include data for each code module such as the following: time spent on development, cost of development, revenue generated, etc. In one embodiment, the cost of development of a particular code module is determined based on the time spent by personnel involved in the development of the code module and their salaries. In various embodiments, the revenue generated by a particular module may be determined in various ways based on the nature of the code modules and their monetization.

For example, code modules may be discreetly sold such that determination of their revenue involves straightforward totaling of sales. In other embodiments, code modules may be monetized together as part of the same overall product. In such cases, revenue for a given code module may be determined to be a portion of the overall revenue for the product based on some measure of the given code module's utility, such as the amount of time users spend utilizing the code module, the number of times the code module is executed, etc. For example, in the context of video game, code modules may correspond to a particular levels or locations in a virtual environment. It may be useful to determine the amount of time spent by users at each level or location, and further determine the revenue generated by their corresponding code modules relative to their costs of development.

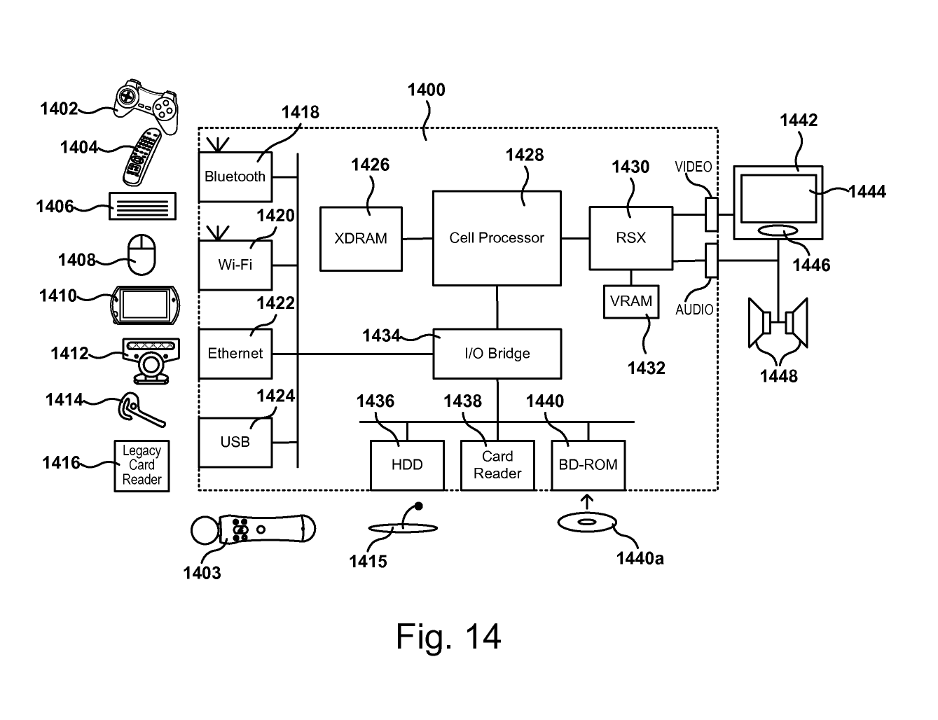

FIG. 14 illustrates hardware and user interfaces that may be used to implement embodiments of the invention. FIG. 14 schematically illustrates the overall system architecture of the Sony® Playstation 3® entertainment device. A system unit 1400 is provided, with various peripheral devices connectable to the system unit 1400. The system unit 1400 comprises: a Cell processor 1428; a Rambus® dynamic random access memory (XDRAM) unit 1426; a Reality Synthesizer graphics unit 1430 with a dedicated video random access memory (VRAM) unit 1432; and an I/O bridge 1434. The system unit 1400 also comprises a Blu Ray® Disk BD-ROM® optical disk reader 1440 for reading from a disk 1440a and a removable slot-in hard disk drive (HDD) 1436, accessible through the I/O bridge 1434. Optionally the system unit 1400 also comprises a memory card reader 1438 for reading compact flash memory cards, Memory Stick® memory cards and the like, which is similarly accessible through the I/O bridge 1434.

The I/O bridge 1434 also connects to six Universal Serial Bus (USB) 2.0 ports 1424; a gigabit Ethernet port 1422; an IEEE 802.11b/g wireless network (Wi-Fi) port 1420; and a Bluetooth® wireless link port 1418 capable of supporting of up to seven Bluetooth connections.

In operation, the I/O bridge 1434 handles all wireless, USB and Ethernet data, including data from one or more game controllers 1402-1403. For example when a user is playing a game, the I/O bridge 1434 receives data from the game controller 1402-1403 via a Bluetooth link and directs it to the Cell processor 1428, which updates the current state of the game accordingly.

The wireless, USB and Ethernet ports also provide connectivity for other peripheral devices in addition to game controllers 1402-1403, such as: a remote control 1404; a keyboard 1406; a mouse 1408; a portable entertainment device 1410 such as a Sony PSP® entertainment device; a video camera such as a PlayStation®Eye Camera 1412; a microphone headset 1414; and a microphone 1415. Such peripheral devices may therefore in principle be connected to the system unit 1400 wirelessly; for example the portable entertainment device 1410 may communicate via a Wi-Fi ad-hoc connection, whilst the microphone headset 1414 may communicate via a Bluetooth link.

The provision of these interfaces means that the Playstation 3 device is also potentially compatible with other peripheral devices such as digital video recorders (DVRs), set-top boxes, digital cameras, portable media players, Voice over Internet Protocol (IP) telephones, mobile telephones, printers and scanners. In addition, a legacy memory card reader 1416 may be connected to the system unit via a USB port 1424, enabling the reading of memory cards of the kind used by the Playstation® or Playstation 2® devices.

The game controllers 1402-1403 are operable to communicate wirelessly with the system unit 1400 via the Bluetooth link, or to be connected to a USB port, thereby also providing power by which to charge the battery of the game controllers 1402-1403. Game controllers 1402-1403 can also include memory, a processor, a memory card reader, permanent memory such as flash memory, light emitters such as an illuminated spherical section, LEDs, or infrared lights, microphone and speaker for ultrasound communications, an acoustic chamber, a digital camera, an internal clock, a recognizable shape facing the game console, and wireless communications using protocols such as Bluetooth®, WiFi™, etc. The recognizable shape can be in a shape substantially of a sphere, a cube, parallelogram, a rectangular parallelepiped, a cone, a pyramid, an imperfect sphere, a soccer ball, a football or rugby ball, an imperfect sphere, a section of a sphere, a truncated pyramid, a truncated cone, a baseball bat, a truncated cube, a polyhedron, a star, etc., or a combination of two of more of these shapes.

Game controller 1402 is a controller designed to be used with two hands, and game controller 1403 is a single-hand controller with a ball attachment. In addition to one or more analog joysticks and conventional control buttons, the game controller is susceptible to three-dimensional location determination. Consequently gestures and movements by the user of the game controller may be translated as inputs to a game in addition to or instead of conventional button or joystick commands. Optionally, other wirelessly enabled peripheral devices such as the Sony PSP® portable device may be used as a controller. In the case of the Sony PSP® portable device, additional game or control information (for example, control instructions or number of lives) may be provided on the screen of the device. Other alternative or supplementary control devices may also be used, such as a dance mat (not shown), a light gun (not shown), a steering wheel and pedals (not shown) or bespoke controllers, such as a single or several large buttons for a rapid-response quiz game (also not shown).

The remote control 1404 is also operable to communicate wirelessly with the system unit 1400 via a Bluetooth link. The remote control 1404 comprises controls suitable for the operation of the Blu Ray™ Disk BD-ROM reader 1440 and for the navigation of disk content.

The Blu Ray™ Disk BD-ROM reader 1440 is operable to read CD-ROMs compatible with the Playstation and PlayStation 2 devices, in addition to conventional pre-recorded and recordable CDs, and so-called Super Audio CDs. The reader 1440 is also operable to read DVD-ROMs compatible with the Playstation 2 and PlayStation 3 devices, in addition to conventional pre-recorded and recordable DVDs. The reader 1440 is further operable to read BD-ROMs compatible with the Playstation 3 device, as well as conventional pre-recorded and recordable Blu-Ray Disks.

The system unit 1400 is operable to supply audio and video, either generated or decoded by the Playstation 3 device via the Reality Synthesizer graphics unit (RSX) 1430, through audio and video connectors to a display and sound output device 1442 such as a monitor or television set having a display 1444 and one or more loudspeakers 1446, or stand-alone speakers 1448. In one embodiment, voice and gaze inputs are utilized to play sound toward specific audio speakers according to the POG of the user. The audio connectors 1450 may include conventional analogue and digital outputs whilst the video connectors 1452 may variously include component video, S-video, composite video and one or more High Definition Multimedia Interface (HDMI) outputs. Consequently, video output may be in formats such as PAL or NTSC, or in 720p, 1080i or 1080p high definition.

Audio processing (generation, decoding and so on) is performed by the Cell processor 1428. The Playstation 3 device's operating system supports Dolby® 5.1 surround sound, Dolby® Theatre Surround (DTS), and the decoding of 7.1 surround sound from Blu-Ray® disks.

In the present embodiment, the video camera 1412 comprises a single Charge Coupled Device (CCD), an LED indicator, and hardware-based real-time data compression and encoding apparatus so that compressed video data may be transmitted in an appropriate format such as an intra-image based MPEG (motion picture expert group) standard for decoding by the system unit 1400. The camera LED indicator is arranged to illuminate in response to appropriate control data from the system unit 1400, for example to signify adverse lighting conditions. Embodiments of the video camera 1412 may variously connect to the system unit 1400 via a USB, Bluetooth or Wi-Fi communication port. Embodiments of the video camera may include one or more associated microphones and also be capable of transmitting audio data. In embodiments of the video camera, the CCD may have a resolution suitable for high-definition video capture. In use, images captured by the video camera may for example be incorporated within a game or interpreted as game control inputs. In another embodiment the camera is an infrared camera suitable for detecting infrared light.

In general, in order for successful data communication to occur with a peripheral device such as a video camera or remote control via one of the communication ports of the system unit 1400, an appropriate piece of software such as a device driver should be provided. Device driver technology is well-known and will not be described in detail here, except to say that the skilled man will be aware that a device driver or similar software interface may be required in the present embodiment described.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A system for social interactive code development of a plurality of code modules, comprising:
an activity monitor for monitoring access to one or more of the plurality of code modules;
a social feedback engine for initiating a communication based on triggering a predefined access threshold set for at least part of a specific one of the plurality of code modules.

2. The system of claim 1, wherein the predefined access threshold is selected from the group consisting of opening, viewing, or editing the at least part of the specific one of the plurality of code modules.

3. The system of claim 1, wherein the communication is directed to a user that triggers the predefined access threshold.

4. The system of claim 1, wherein the communication is directed to an owner of the at least part of a specific one of the plurality of code modules.

5. The system of claim 1, wherein the communication comprises a real-time communication link.

6. The system of claim 5, wherein the real-time communication link is defined between a user that triggers the predefined access threshold and an owner of the at least part of a specific one of the plurality of code modules.

7. The system of claim 5, wherein the real-time communication link includes one of a live view and a history view of the at least part of the specific one of the plurality of code modules.

8. The system of claim 1, further comprising,
a tag generator for generating a tag associated with the at least part of the specific one of the plurality of code modules, the tag defining the communication and the predefined access threshold.

9. The system of claim 1, wherein the initiating a communication is based on a proximity of the at least part of the specific one of the plurality of code modules to another portion of one of the plurality of code modules.

10. The system of claim 9, wherein the proximity is defined by a parent-child relationship.

11. The system of claim 1, further comprising,
a user interface for providing access to one or more of the plurality of code modules.

12. The system of claim 11, wherein the user interface includes a value data presenter for presenting value data regarding at least part of one or more of the plurality of code modules, the value data defining a relative level of importance.

13. The system of claim 12, wherein the value data includes metrics derived from one or more of development time, play time, test time, and cost.

14. A method for social interactive code development of a plurality of code modules, comprising:
monitoring access to one or more of the plurality of code modules;
initiating a communication based on triggering a predefined access threshold set for at least part of a specific one of the plurality of code modules.

15. The method of claim 14, wherein the predefined access threshold is selected from the group consisting of opening, viewing, or editing the at least part of the specific one of the plurality of code modules.

16. The method of claim 14, wherein the communication is directed to a user that triggers the predefined access threshold.

17. The method of claim 14, wherein the communication is directed to an owner of the at least part of a specific one of the plurality of code modules.

18. The method of claim 14, wherein the communication comprises a real-time communication link.

19. The method of claim 18, wherein the real-time communication link is defined between a user that triggers the predefined access threshold and an owner of the at least part of a specific one of the plurality of code modules.

20. The method of claim 18, wherein the real-time communication link includes one of a live view and a history view of the at least part of the specific one of the plurality of code modules.

21. The method of claim 14, further comprising,
generating a tag associated with the at least part of the specific one of the plurality of code modules, the tag defining the communication and the predefined access threshold.

22. The method of claim 14, wherein the initiating a communication is based on a proximity of the at least part of the specific one of the plurality of code modules to another portion of one of the plurality of code modules.

23. The method of claim 22, wherein the proximity is defined by a parent-child relationship.

24. The method of claim 14, further comprising,
providing access to one or more of the plurality of code modules.

25. The method of claim 24, wherein providing access includes presenting value data regarding at least part of one or more of the plurality of code modules, the value data defining a relative level of importance.

26. The method of claim 25, wherein the value data includes metrics derived from one or more of development time, play time, test time, and cost.
